(19) United States
(12) Patent Application Publication
(10) Pub. No.: US 2024/0032102 A1
(43) Pub. Date: Jan. 25, 2024

(54) UNIFIED RANDOM ACCESS (RA) DESIGN FOR MULTIPLE FEATURES BACKGROUND

(71) Applicant: Apple Inc., Cupertino, CA (US)

(72) Inventors: Fangli XU, Beijing (CN); Yuqin CHEN, Beijing (CN); Yushu ZHANG, Beijing (CN); Chunhai YAO, Beijing (CN); Haijing HU, Los Gatos, CA (US); Wei ZENG, Saratoga (CA); Dawei ZHANG, Saratoga, CA (US)

(73) Assignee: Apple Inc., Cupertino, CA (US)

(21) Appl. No.: 17/441,150

(22) PCT Filed: Jul. 23, 2021
(86) PCT No.: PCT/CN2021/108151

§ 371 Date: Jan. 26, 2023

(51) Int. Cl. H04W 74/08

(52) U.S. Cl. CPC H04W 74/0833

(57) ABSTRACT

Some aspects of this disclosure relate to apparatuses and methods for implementing unified RACH for multiple features. For example, some aspects of this disclosure relate to a method including determining, by a user equipment (UE), a feature to be indicated at an initial access of the UE to a base station and determining whether the UE and the base station support feature specific random access (RA) procedure for the feature. The method further includes determining whether a condition for the feature is satisfied in response to determining that both the UE and the base station support the feature specific RA procedure for the feature. In response to determining that the condition is satisfied, the method includes selecting a feature specific Random Access Channel (RACH) resource and perform a 4-step RA procedure or a 2-step RA procedure based on the selected feature specific RACH resource.

### BACKGROUND

### Field

The described aspects generally relate to mechanisms for Random Access (RA) procedure including a unified RA design for multiple features supported by a user equipment (UE) and a network.

### Related Art

RA procedure (or Random Access Channel (RACH) procedure as referred herein in some aspects) is a procedure that can be used by the UE and the network for an initial access of the UE to the network. The RA procedure for the initial connection can be triggered when the UE is first joining the network and has data to send to the network. In another example, the RA procedure can be triggered when the UE is paged by the network. In some examples, a 4-step RA (or 4-step RACH as referred herein in some aspects) is configured for the UE for its initial access. In some examples, a 2-step RA (or 2-step RACH as referred herein in some aspects) is configured for the UE for its initial access.

### SUMMARY

Some aspects of this disclosure relate to apparatuses and methods for implementing unified RA for multiple features. For example, some aspects of this disclosure relate to apparatuses and methods for implementing mechanisms to unify RA design across multiple features, which may support the multiple features at the same time. The multiple features can include, but are not limited to, reduced capability (RedCap), coverage enhancement, Radio Access Network (RAN) slicing, small data transmission, and the like. According to some aspects, feature identification during the RA procedure can be done using, for example, different RACH occasions (ROs) or different preamble configuration.

Some aspects of this disclosure relate to a user equipment (UE). The UE includes a transceiver configured to enable wireless communication with a base station and a processor communicatively coupled to the transceiver. The processor can be configured to determine a feature to be indicated at an initial access of the UE to the base station and determine whether the UE and the base station support feature specific random access (RA) procedure for the feature. The processor can further be configured to determine whether a condition for the feature is satisfied in response to determining that both the UE and the base station support the feature specific RA procedure for the feature. In response to determining that the condition is satisfied, the processor is further configured to select a feature specific Random Access Channel (RACH) resource and perform a 4-step RA procedure or a 2-step RA procedure based on the selected feature specific RACH resource.

In some aspects, the feature is one of a plurality of features to be indicated at the initial access of the UE to the base station. The feature specific RACH resource can include one or more RACH occasions or one or more preambles partitioned based on the plurality of features.

In some aspects, the feature specific RACH resource can include a plurality of Physical Random Access Channel (PRACH) configuration indexes associated with the plurality of features. In some aspects, the feature specific RACH resource can include a plurality of sets of subframes for a PRACH configuration index associated with the plurality of features. In some aspects, the feature specific RACH resource can include a plurality of frequency resources of a RACH occasion associated with the plurality of features. In some aspects, the feature specific RACH resource can include a plurality of RACH occasions associated with the plurality of features, where the plurality of RACH occasions are spread in a frequency domain and a time domain. In some aspects, the feature specific RACH resource can include a plurality of preamble offsets associated with the plurality of features.

In some aspects, the processor is further configured to select the feature specific RACH resource based on the determined feature and a feature specific RACH configuration. In some aspects, the feature specific RACH configuration can include a general RACH configuration and a plurality of specific RACH configurations. The general RACH configuration can include a number of the plurality of specific RACH configurations and a mapping between a plurality of features and the plurality of specific RACH configurations. Each of the plurality of specific RACH configurations can include information associated with a 4-step RA procedure or a 2-step RA procedure associated with the corresponding feature of the plurality of features.

In some aspects, the feature specific RACH configuration can include a first feature specific RACH configuration associated with the 4-step RA procedure and a second feature specific RACH configuration associated with the 2-step RA procedure

In some aspects, the processor is further configured to determine whether the UE and the base station support a second feature specific RA procedure for a second features. In response to determining that the UE or the base station does not support the second feature specific RA procedure for the second feature, the processor can perform the 4-step RA procedure or the 2-step RA procedure based on the selected feature specific RACH resource. In response to determining that the UE and the base station support the second feature specific RA procedure for the second feature, the processor can determine whether a second condition for the second feature is satisfied. In response to determining that the second condition is satisfied, the processor can select the feature specific RACH resource for the feature or a second feature specific RACH resource for the second feature. The processor can also perform a 4-step RA procedure or a 2-step RA procedure based on the selected feature specific RACH resource or the selected second feature specific RACH resource. In response to determining that the second condition is not satisfied, the processor can perform the 4-step RA procedure or the 2-step RA procedure based on the selected feature specific RACH resource.

In some aspects, the process is configured to select the feature specific RACH resource for the feature or the second feature specific RACH resource based on priorities assigned to the feature and the second feature.

Some aspects of this disclosure relate to a method including determining, by a user equipment (UE), a feature to be indicated at an initial access of the UE to a base station and determining whether the UE and the base station support feature specific random access (RA) procedure for the feature. The method further includes determining whether a condition for the feature is satisfied in response to determining that both the UE and the base station support the feature specific RA procedure for the feature. In response to determining that the condition is satisfied, the method includes selecting a feature specific Random Access Channel (RACH) resource and perform a 4-step RA procedure or a 2-step RA procedure based on the selected feature specific RACH resource.

Some aspects of this disclosure relate to a non-transitory computer-readable medium storing instructions. When the instructions are executed by a processor of a base station, the instructions cause the processor to perform operations including determining, by a user equipment (UE), a feature to be indicated at an initial access of the UE to a base station and determining whether the UE and the base station support feature specific random access (RA) procedure for the feature. The operations further include determining whether a condition for the feature is satisfied in response to determining that both the UE and the base station support the feature specific RA procedure for the feature. In response to determining that the condition is satisfied, the operations include selecting a feature specific Random Access Channel (RACH) resource and perform a 4-step RA procedure or a 2-step RA procedure based on the selected feature specific RACH resource.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing unified RA procedure for multiple features, according to some aspects of the disclosure.

FIG. 2 illustrates a block diagram of an example system of an electronic device implementing unified RA procedure for multiple features, according to some aspects of the disclosure.

FIGS. 3A and 3B illustrate exemplary signaling for RA procedures, according to some aspects of this disclosure.

FIG. 4A illustrates an exemplary RACH configuration within frequency and time for a 4-step RA procedure, according to some aspects of this disclosure.

FIG. 4B illustrates one exemplary preamble partitioning, according to some aspects of this disclosure.

FIG. 4C illustrates one exemplary preamble partitioning, according to some aspects of this disclosure.

FIG. 5 illustrates an exemplary preamble partitioning, according to some aspects of this disclosure.

FIG. 6 illustrates an example method for a system (for example, a UE) performing unified RA procedure for multiple features, according to some aspects of the disclosure.

FIG. 7 illustrates another exemplary method for a system (for example, a UE) performing unified RA procedure for multiple features, according to some aspects of the disclosure.

FIG. 8 is an example computer system for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure relate to apparatuses and methods for implementing unified RA procedure (or RACH procedure as referred to in some aspects) for multiple features. For example, some aspects of this disclosure relate to apparatuses and methods for implementing mechanisms to unify RACH design across multiple features. According to some aspects, feature identification during the RA procedure can be done using, for example, different RACH occasions (ROs) or different preamble configuration.

In some examples, the aspects of this disclosure can be performed by a network and/or a UE that operates according to Release 17 (Rel-17) and/or Rel-17 new radio (NR) of 5^{th} generation (5G) wireless technology for digital cellular networks as defined by 3rd Generation Partnership Project (3GPP). Additionally, or alternatively, the aspects of this disclosure can be performed by a network and/or a UE that operates according to the Release 15 (Rel-15), Release 16 (Rel-16), or others. However, the aspects of this disclosure are not limited to these examples, and one or more mechanisms of this disclosure can be implemented by other network(s) and/or UE(s) for using a unified RA procedure to support multiple features.

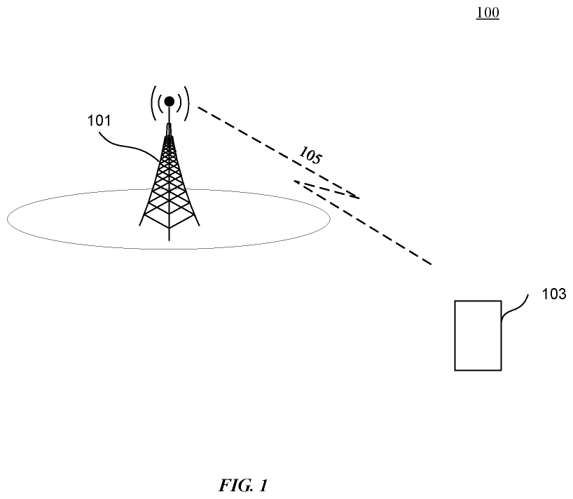

FIG. 1 illustrates an example system 100 implementing unified RA procedure for multiple features, according to some aspects of the disclosure. Example system 100 is provided for the purpose of illustration only and does not limit the disclosed aspects.

System 100 may include, but is not limited to, network node (for example, base stations such as eNBs, gNBs, and the like) 101 and electronic device (for example, a UE) 103. Electronic device 103 (hereinafter referred to as UE 103) can include an electronic device configured to operate based on a wide variety of wireless communication techniques. These techniques can include, but are not limited to, techniques based on 3rd Generation Partnership Project (3GPP) standards. For example, UE 103 can include an electronic device configured to operate using Rel-17 or other. UE 103 can include, but is not limited to, wireless communication devices, smart phones, laptops, desktops, tablets, personal assistants, monitors, televisions, wearable devices, Internet of Things (IoTs), vehicle's communication devices, and the like. Network node 101 (herein referred to as a base station or a cell) can include one or more nodes configured to operate based on a wide variety of wireless communication techniques such as, but not limited to, techniques based on 3GPP standards. For example, base station 101 can include one or more nodes configured to operate using Rel-17 or others.

According to some aspects, UE 103 is not connected to base station 101. UE 103 can use the RA procedure for initial access and initial connection to base station 101. According to some examples, the initial access can be done using carrier 105. According to some aspects, carrier 105 can include one carrier. Additionally, or alternatively, carrier 105 can include two or more component carriers (CC). In other words, UE 105 can implement carrier aggregation (CA). For example, UE 103 can use multiple carriers for communication with base station 101.

According to some aspects, legacy RACH can include a 2-step RA procedure and/or a 4-step RA procedure. For example, in Rel-15, the 4-step RA procedure is configured for the UE to perform its initial access. In Rel-16, both 4-step RA and 2-step RA procedures can be configured within one cell for the UE to its perform initial access. According to some examples, the 2-step and 4-step RACH resources can be differentiated using different ROs and/or preamble combination. According to some aspects, the legacy 2-step RACH and 4-step RA procedures can be based on, for example, Technical Specifications (TS) 38.211 Section 6.3.3.2, TS 38.213 Section 8, and/or TS 38.321 Section 5.1.

Rel-17 includes multiple features that can be supported by the UE (e.g., UE 103) and the network (e.g., base station 101). These features can include, but are not limited to, RedCap, coverage enhancement, RAN slicing, small data transmission, and the like. The legacy RA procedures do not support multiple features and using feature specific RA procedures. According to some aspects, system 100 supports using a RA procedure for multiple features simultaneously or substantially simultaneously. In some examples, UE 103 can identify the feature(s) it is using during its initial access to base station 101 using the unified RA procedure. As discussed in more detail below, the feature identification during the unified RA procedure may be performed using different RO and/or different preamble configuration.

According to some aspects, the unified RA procedure can use RO partitioning for supporting multiple features simultaneously or substantially simultaneously. In one example, Physical Random Access Channel (PRACH) configuration index can be used to indicate different RO patterns for different features. The different PRACH configuration indexes can indicate the different RO timing locations. In other words, different PRACH configuration indexes are used for different RO patterns for different features supported by base station 101 and UE 103. In some examples, the PRACH configuration indexes can be defined in Technical Specification TS38.211 section 6.3.3.2. However, other configuration indexes can be used to indicate different RO patterns.

Additionally, or alternatively, different RO subsets can be used for different features in the unified RA procedure. For example, for the same PRACH configuration index, multiple ROs can be in one period. Different RO subsets can be used for different features.

Additionally, or alternatively, different frequency resources can be used for different features in the unified RA procedure. For example, the unified RA procedure can configure the same RO time location for multiple features, but configure different frequency resources for different features.

Additionally, or alternatively, different frequency resources and time resources can be used for different features in the unified RA procedure. For example, the unified RA procedure can configure different ROs in Frequency Division Multiplexing (FDM) and Time Division Multiplexing (TDM) (e.g., using different frequency and time resources) for different features. In a non-limiting example, for the ROs configured within a cell (e.g., configured by prach-ConfigurationIndex and msg1-FDM), each RO can be sequentially numbered: first, in increasing order of frequency resource indexes for frequency multiplexed ROs; second, in increasing order of time resource indexes for time multiplexed ROs within a PRACH slot; and third, in increasing order of indexes for PRACH slots. The unified RA procedure can configure different ROs for the different features.

Additionally, or alternatively, to using RO partitioning, the unified RA procedure can use preamble partitioning for supporting multiple features simultaneously or substantially simultaneously, according to some aspects. In some examples, the preamble partitioning can be performed when shared ROs are used. According to some aspects, for each feature, the preamble information can include the total preamble number per synchronization signal block (SSB), and the preamble-start-index per SSB.

According to some aspects, system 100 can define one or more RACH configurations for the unified RA procedure. In some examples, the RACH configuration can include a general RACH configuration defining multiple specific RACH configurations. Each one of the multiple specific RACH configurations are associated with each feature of system 100. Alternatively, the RACH configuration can include one common RACH occasion pool for all features for 4-step RACH and one common RACH occasion pool for all features for 2-step RACH.

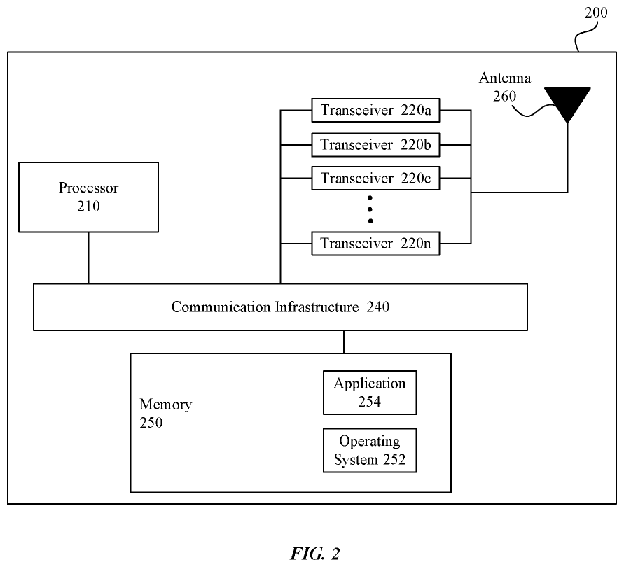

FIG. 2 illustrates a block diagram of an example system 200 of an electronic device implementing unified RA procedure for multiple features, according to some aspects of the disclosure. System 200 may be any of the electronic devices (e.g., base stations 101, UE 103) of system 100. System 200 includes processor 210, one or more transceivers 220a-220n, communication infrastructure 240, memory 250, operating system 252, application 254, and antenna 260. Illustrated systems are provided as exemplary parts of system 200, and system 200 can include other circuit(s) and subsystem(s). Also, although the systems of system 200 are illustrated as separate components, the aspects of this disclosure can include any combination of these, less, or more components.

Memory 250 may include random access memory (RAM) and/or cache, and may include control logic (e.g., computer software) and/or data. Memory 250 may include other storage devices or memory such as, but not limited to, a hard disk drive and/or a removable storage device/unit. According to some examples, operating system 252 can be stored in memory 250. Operating system 252 can manage transfer of data from memory 250 and/or one or more applications 254 to processor 210 and/or one or more transceivers 220a-220n. In some examples, operating system 252 maintains one or more network protocol stacks (e.g., Internet protocol stack, cellular protocol stack, and the like) that can include a number of logical layers. At corresponding layers of the protocol stack, operating system 252 includes control mechanism and data structures to perform the functions associated with that layer.

According to some examples, application 254 can be stored in memory 250. Application 254 can include applications (e.g., user applications) used by wireless system 200 and/or a user of wireless system 200. The applications in application 254 can include applications such as, but not limited to, Siri™, FaceTime™, radio streaming, video streaming, remote control, and/or other user applications.

System 200 can also include communication infrastructure 240. Communication infrastructure 240 provides communication between, for example, processor 210, one or more transceivers 220a-220n, and memory 250. In some implementations, communication infrastructure 240 may be a bus. Processor 210 together with instructions stored in memory 250 performs operations enabling system 200 of system 100 to implement unified RA procedure for multiple features, as described herein.

One or more transceivers 220a-220n transmit and receive communications signals that support the unified RA procedure for multiple features, according to some aspects, and may be coupled to antenna 260. Antenna 260 may include one or more antennas that may be the same or different types. One or more transceivers 220a-220n allow system 200 to communicate with other devices that may be wired and/or wireless. In some examples, one or more transceivers 220a-220n can include processors, controllers, radios, sockets, plugs, buffers, and like circuits/devices used for connecting to and communication on networks. According to some examples, one or more transceivers 220a-220n include one or more circuits to connect to and communicate on wired and/or wireless networks.

According to some aspects, one or more transceivers 220a-220n can include a cellular subsystem, a WLAN subsystem, and/or a Bluetooth™ subsystem, each including its own radio transceiver and protocol(s) as will be understood by those skilled arts based on the discussion provided herein. In some implementations, one or more transceivers 220a-220n can include more or fewer systems for communicating with other devices.

In some examples, one or more transceivers 220a-220n can include one or more circuits (including a WLAN transceiver) to enable connection(s) and communication over WLAN networks such as, but not limited to, networks based on standards described in IEEE 802.11. Additionally, or alternatively, one or more transceivers 220a-220n can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 220n can include a Bluetooth™ transceiver.

Additionally, one or more transceivers 220a-220n can include one or more circuits (including a cellular transceiver) for connecting to and communicating on cellular networks. The cellular networks can include, but are not limited to, 3G/4G/5G networks such as Universal Mobile Telecommunications System (UMTS), Long-Term Evolution (LTE), and the like. For example, one or more transceivers 220a-220n can be configured to operate according to one or more of Rel-15, Rel-16, Rel-17, or other of the 3GPP standards.

According to some aspects, processor 210, alone or in combination with computer instructions stored within memory 250, and/or one or more transceiver 220a-220n, implements unified RA procedure for multiple features, as discussed herein.

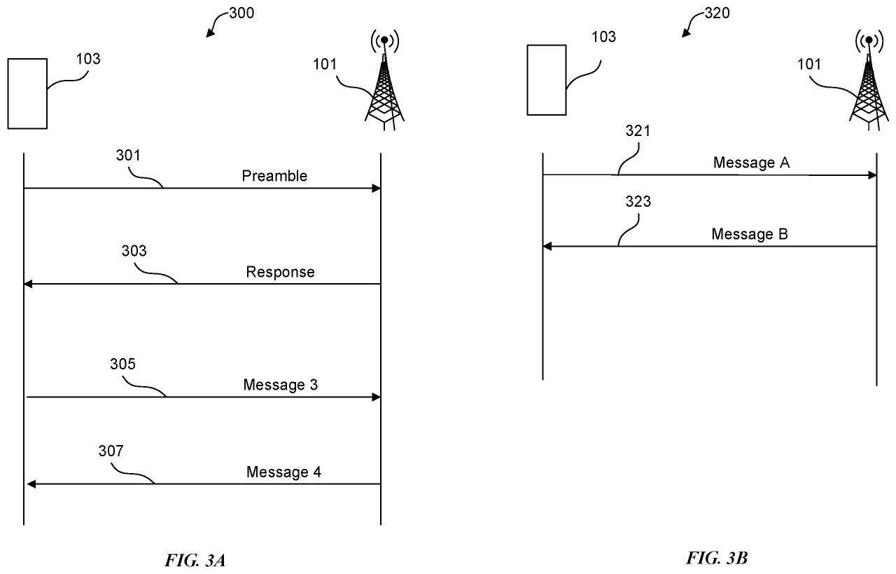

FIGS. 3A and 3B illustrate exemplary signaling for Random Access (RA) procedures, according to some aspects of this disclosure. FIG. 3A illustrates an exemplary signaling 300 for 4-step RA procedure that can be used with the unified RA procedure for multiple features of this disclosure. FIG. 3B illustrates an exemplary signaling 320 for 2-step RA procedure that can be used with the unified RA procedure for multiple features of this disclosure.

According to some aspects, as illustrated in FIG. 3A, UE 103 can send preamble 301 (e.g., RA preamble or RACH preamble) to base station 101 to initiate UE 103's initial access. As discussed in more detail below, UE 103 can select preamble 301 and/or its RACH occasion (RO) based on the unified RA procedure of this disclosure. According to some aspects, UE 103 transmits preamble 301 on PRACH. In some examples, preamble 301 can also be referred to as message 1 (Msg 1).

After transmitting preamble 301, UE 103 can monitor the downlink (DL) channel for a response from base station 101. If UE 103 does not receive any response from base station 101, UE 103 can retry transmitting preamble 301. According to some aspects, base station 101 can send RA response 303 to UE 103. In some examples, RA response 303 can include information for UE 103 to transmit additional signal(s) to base station 101. For example, RA response 303 (also referred to as Msg 2) can include timing information for UE 103 to transmit additional signal(s) to base station 101. Also, RA response 303 can include temporary Cell Radio Network Temporary Identifier (TC-RNTI). However, the aspects of this disclosure are not limited to these examples and RA response 303 can include other information.

Messages 305 and 307 can be used for collision resolution. In one example, message 305 (also referred to as Msg 3) can be a Radio Resource Control (RRC) that UE 103 transmits to base station 105. Base station 101 can transmit response message 307 (also referred to as Msg 4) in response to message 305. Messages 305 and 307 can be used for collision resolution for possible collisions between UE 103 and other UEs the communicate with base station 101.

After the RA procedure is completed, UE 103 moves to a connected state and can communicated with base station 101 using parameters set and/or negotiated by base station 101. The exemplary signaling 300 for 4-step RA procedure can be used with the unified RA procedure of this disclosure.

FIG. 3B illustrates exemplary signaling 320 for 2-step RA procedure that can be used with the unified RA procedure for multiple features of this disclosure. According to some aspects, message 321 of signaling 320 for 2-step RA procedure can include the combination of preamble 301 and message 305 of FIG. 3A. In other words, message 321 of FIG. 3B can include a combination of Msg 1 and Msg 3. As discussed in more detail below, UE 103 can select preamble of message 321 and/or its RACH occasion (RO) based on the unified RA procedure of this disclosure. In some aspects, message 321 can be referred to as Msg A transmission from UE 103 to base station 101.

Additionally, message 323 of FIG. 3B can include a combination of RA response 303 and message 307. In other words, message 323 of FIG. 3B can include a combination of Msg 2 and Msg 4. In some aspects, message 323 can be referred to as Msg B transmission from base station 101 to UE 103.

Although some exemplary information of messages 301, 303, 305, 307, 321, and 323 are discussed, these message can include other information used for 4-step and/or 2-step RA procedures.

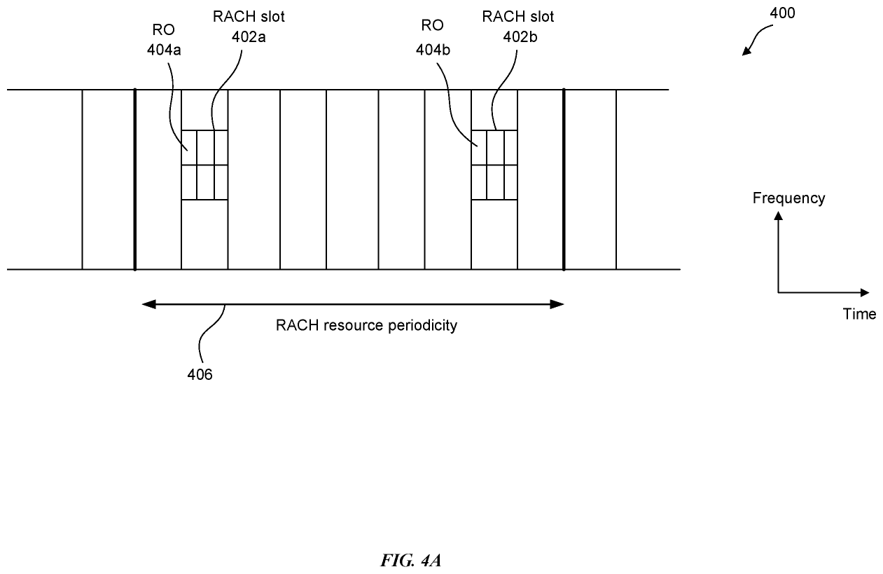

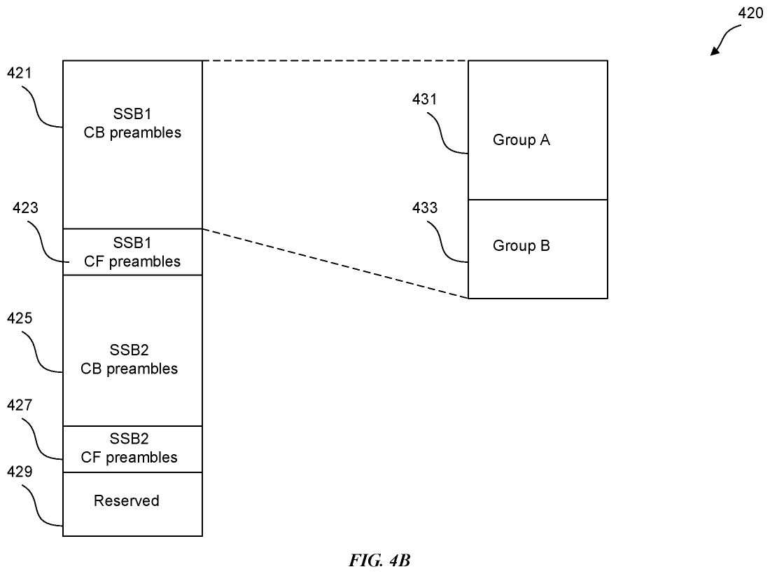

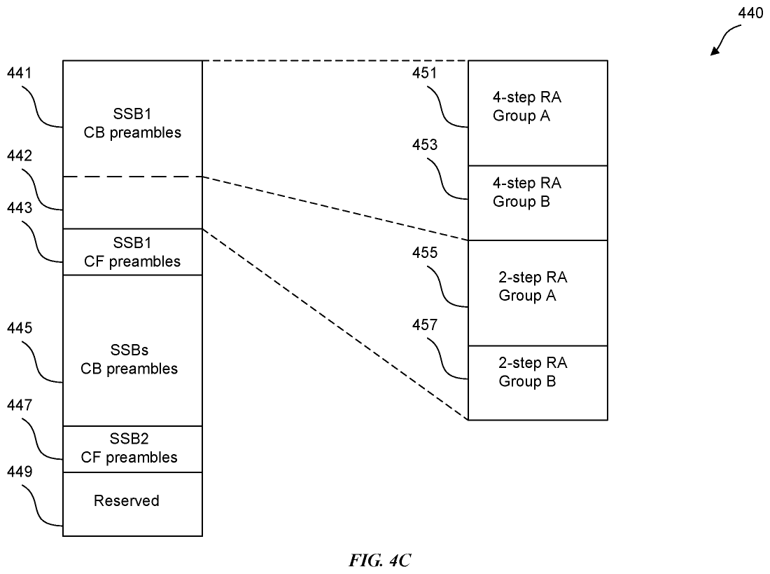

FIGS. 4A and 4B illustrate one exemplary RO and preamble configuration for 4-step RA procedure, according to some aspects of this disclosure. According to some examples, a RACH resource can include a RO and/or a preamble. A preamble can include a combination (e.g., a concatenation) of short sequences used by the UE for its initial access to the base station.

FIG. 4A illustrates exemplary RACH configuration 400 within frequency and time for a 4-step RA procedure, according to some aspects of this disclosure. RACH configuration 400 can include one or more RACH slots 402 within RACH resource periodicity 406. Each RACH slot 402a or 402b can include one or more RACH occasion (RO) 404a or 404b (collectively referred to as RO 404). In the example of FIG. 4A, RACH slot 402a includes six ROs 404a including TDM and FDM. In this example, the ROs are arranged in time domain and frequency domain. According to some aspects, each RO 404 can carry one or more preambles. For example, each RO 404 illustrated in FIG. 4A can carry up to 64 preambles. In a non-limiting example, an RO can carry three short preambles or one long preamble. UE 103 can use one or more ROs 404 within one or more RACH slots 402 to transmit its preamble (e.g., preamble 301 of FIG. 3A).

Although ROs 404 are illustrated to be arranged in frequency domain, the aspects of this disclosure are not limited to this example and ROs 404 can be spread in frequency domain, in time domain, or both frequency and time domains. Also, although FIG. 4A is discussed with respect to the 4-step RA procedure, similar RACH configuration can also be used for 2-step RA procedure.

According to some aspects, each one of RACH slots 402 can include one or more frequency domain ROs 404, which are arranged consecutively in the frequency domain and occupy a certain number of resource blocks. The number of resource block can depend on the preamble transmission bandwidth, according to some examples.

According to some aspects, RACH configuration 400 can include two types of preamble format: long and short. The short preamble can have multiple preamble transmissions multiplexed in time within a single RACH slot 402. In a non-limiting example, in each such RACH time/frequency occasion there can be 64 preambles available for transmission. However, the aspects of this disclosure are not limited to these examples and other number of preambles can be used.

As discussed in more detail below, one or more ROs 404 can be selected for different features using the unified RA procedure of this disclosure.

In addition to, or in alternative to, using one or more RO by the UE (e.g., UE 103 of FIG. 1), the UE can use one or more preambles for UE's initial access to the base station. FIG. 4B illustrates one exemplary preamble partitioning 420, according to some aspects of this disclosure. According to some aspects, each RO 404 of FIG. 4A can carry one or more preambles as partitioned in preamble partitioning 420 of FIG. 4B. According to some examples, RACH resource can include ROs (e.g., ROs 404) and/or preambles. Preamble partitioning 420 of FIG. 4B is for two synchronization signal blocks (SSBs) SSB1 and SSB2 within a single RO. However, the aspects of this disclosure are not limited to this example and preamble partitioning 420 can be used for any number of SSBs.

As illustrated in FIG. 4B, preamble partitioning 420 includes Contention Based (CB) preamble indexes for SSB1 421 and Contention Free (CF) preamble indexes for SSB1 423. The sum of 421 and 423 is the total number of preamble indexes for SSB1. Similarly, as illustrated in FIG. 4B, preamble partitioning 420 includes CB preamble indexes for SSB2 425 and CF preamble indexes for SSB2 427. The sum of 425 and 427 is the total number of preamble indexes for SSB2. Preamble partitioning 420 also includes reserved preamble 429.

According to some aspects, CB preamble indexes 421 and/or 425 can be divided into two or more groups. For example, CB preamble indexes for SSB1 421 can be divided into Group A 431 and Group B 433. Depending on preamble indexes in which group (Group A or Group B) received by base station 101, base station 101 can determine a message size for messages between UE 103 and base station 101.

Preamble partitioning 420 is discussed for preamble partitioning within a single RO, e.g. single RO 404. However, the network (e.g., system 101 including base station 101) can use other methods for preamble partitioning within a single RO or over multiple ROs. In some examples, SSB and RO/preamble mapping can done in an order. For example, each SSB can be mapped to a number of ROs 404 of FIG. 4A in an increasing order of preamble indexes within a single RO. In another example, SSB and RO/preamble mapping can done in the frequency domain for the frequency multiplexed ROs. In another example, SSB and RO/preamble mapping can done in time domain for the time multiplexed ROs within a RACH slot (assuming short-preamble format is used). In another example, SSB and RO/preamble mapping can done in the time domain between RACH slots.

According to some examples, the RACH resources (e.g., ROs and/or preambles) for the 2-step RA procedure can be shared with or be separate from the RACH resources for the 4-step RA procedure. In one example, if the RACH resources for the 2-step RA procedure are separate from the RACH resources for the 4-step RA procedure, the RO and preamble selection for the 2-step RA procedure can be the same as the RO and preamble selection for the 4-step RA procedure (e.g., using FIGS. 4A and/or 4B).

In one example, if the RACH resources for the 2-step RA procedure are shared with the RACH resources for the 4-step RA procedure, then the preamble selection for the 2-step RA procedure can be based on a preamble partitioning illustrated in FIG. 4C.

FIG. 4C illustrates one exemplary preamble partitioning 440, according to some aspects of this disclosure. Preamble partitioning 440 of FIG. 4C is for two synchronization signal blocks (SSBs): SSB1 and SSB2. However, the aspects of this disclosure are not limited to this example and preamble partitioning 440 can be used for any number of SSBs.

As illustrated in FIG. 4C, preamble partitioning 440 includes CB preamble indexes for SSB1 441 for 4-step RA procedure, CB preamble indexes for SSB1 442 for 2-step RA procedure, and CF preamble indexes for SSB1 443 for 4-step RA procedure. The sum of 441, 442, and 443 is the total number of preamble indexes for SSB1 (for 2-step and 4-step RA procedures).

Similarly, as illustrated in FIG. 4C, preamble partitioning 440 can include CB preamble indexes for SSB2 445 and CF preamble indexes for SSB2 447 for 4-step RA procedure. The sum of 445 and 447 is the total number of preamble indexes for SSB2. Preamble partitioning 440 also includes reserved preamble 449.

According to some aspects, CB preamble indexes 441, 442, and/or 445 can be divided into two or more groups. For example, CB preamble indexes for SSB1 441 for 4-step RA procedure can be divided into Group A 451 and Group B 453 for 4-step RA procedure. CB preamble indexes for SSB1 442 for 2-step RA procedure can be divided into Group A 455 and Group B 457 for 2-step RA procedure.

In some examples, SSB-associated CB preamble indexes used for 2-step RA procedure can be similar to CF preamble indexes to a Rel-15 UE.

According to some aspects, system 100 of FIG. 1 is configured to support the unified RA procedure by using RO partitioning and/or preamble partitioning to support the multiple features simultaneously or substantially simultaneously. For example, UE 103 can determine one or more features supported by UE 103 and base station 101. UE 103 can further select one or more feature specific RACH resources (ROs and/or preambles) based on the determined one or more features. According to some examples, the feature specific RACH resource can include one or more ROs and/or one or more preambles partitioned based on a plurality of features associated with the initial access of UE 103 to base station 101. UE 103 can further perform a 4-step RA procedure or a 2-step RA procedure based on the selected feature specific RA resource.

In one example, the feature specific RACH resource includes a plurality of PRACH configuration indexes associated with the plurality of features supported by UE 103 and base station 101. In this example, PRACH configuration index can be used to indicate different RO patterns for different features. The different PRACH configuration indexes can indicate the different RO timing locations. In other words, different PRACH configuration indexes are used for different RO patterns for different features supported by base station 101 and UE 103.

As a non-limiting example, Table 6.3.3.2-2 of TS38.211 defines random access configurations for Frequency Range 1 (FR1) defines 29 PRACH configuration indexes (e.g., PRACH configuration index 0-28). In this example, if two features are used by base station 101 and/or UE 103, PRACH configuration index=0 can be used for feature 1 and PRACH configuration index=1 can be used for feature 2. In this example, PRACH configuration index=0 can have an associated subframe number 1 and PRACH configuration index=1 can have an associated subframe number 4. The unified RA procedure of this disclosure can associate feature 1 via the RO in subframe number 1 (associated with PRACH configuration index=0). Also, the unified RA procedure of this disclosure can associate feature 2 via the RO in subframe number 4 (associated with PRACH configuration index=0). Based on this configuration, the network (e.g., base station 101 of system 100 of FIG. 1) can identify a feature based on the PRACH configuration index used by UE 103.

A portion of Table 6.3.3.2-2 of TS38.211 is provided below as Table 1 as a non-limiting example:

TABLE 1
a portion of Table 6.3.3.2-2 of TS38.211

| | | | | | | | Number | |
|---|---|---|---|---|---|---|---|---|
| | | | | | | | of time- | |
| | | | | | | Number | domain | |
| | | | | | | of | PRACH | |
| | | | | | | PRACH | occasions | |
| RACH | | | | | | slots | within a | |
| Configuration | Preamble | n_{SFN}-mod x = y | | Subframe | Starting | within a | PRACH | PRACH |
| Index | format | x | y | number | symbol | subframe | slot | duration |
| 0 | 0 | 16 | 1 | 1 | 0 | — | — | 0 |
| 1 | 0 | 16 | 1 | 4 | 0 | — | — | 0 |
| 2 | 0 | 16 | 1 | 7 | 0 | — | — | 0 |
| 3 | 0 | 16 | 1 | 9 | 0 | — | — | 0 |
| 4 | 0 | 16 | 1 | 1 | 0 | — | — | 0 |
| 5 | 0 | 8 | 1 | 4 | 0 | — | — | 0 |
| 6 | 0 | 8 | 1 | 7 | 0 | — | — | 0 |
| 7 | 0 | 8 | 1 | 9 | 0 | — | — | 0 |
| 8 | 0 | 8 | 1 | 1 | 0 | — | — | 0 |
| 9 | 0 | 4 | 1 | 4 | 0 | — | — | 0 |
| 10 | 0 | 4 | 1 | 7 | 0 | — | — | 0 |
| 11 | 0 | 4 | 1 | 9 | 0 | — | — | 0 |
| 12 | 0 | 4 | 1 | 1 | 0 | — | — | 0 |
| 13 | 0 | 2 | 1 | 4 | 0 | — | — | 0 |
| 14 | 0 | 2 | 1 | 7 | 0 | — | — | 0 |
| 15 | 0 | 2 | 1 | 9 | 0 | — | — | 0 |
| 16 | 0 | 2 | 0 | 1 | 0 | — | — | 0 |
| 17 | 0 | 1 | 0 | 4 | 0 | — | — | 0 |
| 18 | 0 | 1 | 0 | 7 | 0 | — | — | 0 |
| 19 | 0 | 1 | 0 | 1, 6 | 0 | — | — | 0 |
| 20 | 0 | 1 | 0 | 2, 7 | 0 | — | — | 0 |
| 21 | 0 | 1 | 0 | 3, 8 | 0 | — | — | 0 |
| 22 | 0 | 1 | 0 | 1,4, 7 | 0 | — | — | 0 |
| 23 | 0 | 1 | 0 | 2, 5, 8 | 0 | — | — | 0 |
| 24 | 0 | 1 | 0 | 3, 6, 9 | 0 | — | — | 0 |
| 25 | 0 | 1 | 0 | 0, 2, 4, 6, | 0 | — | — | 0 |
| | | | | 8 | | | | |
| 26 | 0 | 1 | 0 | 1, 3, 5, 7, | 0 | — | — | 0 |
| | | | | 9 | | | | |
| 27 | 0 | 1 | 0 | 0, 1, 2, 3, | 0 | — | — | 0 |
| | | | | 4, 5, 6, 7, | | | | |
| | | | | 8, 9 | | | | |
| 28 | 1 | 1 | 0 | 1 | 0 | — | — | 0 |

The example above is provided for illustration and the aspects of this disclosure are not limited to this example. Other PRACH configuration indexes and their associated subframe numbers can be used for different features supported by base station 101 and UE 103.

Additionally, or alternatively, the feature specific RACH resource can include a plurality of sets of subframes for a PRACH configuration index associated with the plurality of features. For example, for the same PRACH configuration index, different RO subsets can be used for different features. In some examples, for some PRACH configuration indexes, multiple ROs can be in one period. Different RO subsets can be used for different features.

As a non-limiting example, Table 6.3.3.2-2 of TS38.211, discussed above, defines subframes (subframe number 0-9) for PRACH configuration index 27. In this example, the feature specific RACH resource can include a plurality of sets of subframes for PRACH configuration index 27 associated with the plurality of features. For example, if two features are used by base station 101 and/or UE 103, the RO in subframe numbers 2, 4, 6, 8 (e.g., a first set of subframes) can be configured for feature 1 and the RO in subframe numbers 1, 3, 5, 7, 9 (e.g., a second set of subframes) can be configured for feature 2. Based on this configuration, the network (e.g., base station 101 of system 100 of FIG. 1) can identify a feature based on the subframe number of the PRACH configuration index used by UE 103.

The example above is provided for illustration and the aspects of this disclosure are not limited to this example. Other PRACH configuration indexes and their associated subframe numbers can be used for different features supported by base station 101 and UE 103.

Additionally, or alternatively, the feature specific RACH resource can include a plurality of frequency resources of an RO associated with the plurality of features. For example, different frequency resources can be used for different features in the unified RA procedure. For example, the unified RA procedure can configure the same RO time location for multiple features, but configure different frequency resources for different features.

As a non-limiting example, in Table 6.3.3.2-2 of TS38.211, discussed above, PRACH configuration index=1 can be configured. PRACH configuration index=1 has an associated subframe number 4. The ROs are positioned in subframe number 4 with a period of 160 ms. In this example, two ROs can be configured in the frequency domain (e.g., RO-F1, and RO-F2). Different ROs can be configured for two features. For example, RO-F1 can be configured for feature 1 and RO-F2 can be configured for feature 2. Based on this configuration, the network (e.g., base station 101 of system 100 of FIG. 1) can identify a feature based on the frequency resources in the subframe number of the PRACH configuration index used by UE 103.

The example above is provided for illustration and the aspects of this disclosure are not limited to this example. Other PRACH configuration indexes, their associated subframe numbers, and their associated frequency resources can be used for different features supported by base station 101 and UE 103.

Additionally, or alternatively, the feature specific RACH resource can include a plurality of ROs associated with the plurality of features, where the plurality of ROs are spread in a frequency domain and a time domain. In this example, different frequency resources and time resources can be used for different features in the unified RA procedure. For example, the unified RA procedure can configure different ROs in Frequency Division Multiplexing (FDM) and Time Division Multiplexing (TDM) (e.g., using different frequency and time resources) for different features.

In a non-limiting example, for the ROs configured within a cell (e.g., configured by prach-ConfigurationIndex and msg1-FDM), each RO can be sequentially numbered: first, in increasing order of frequency resource indexes for frequency multiplexed ROs; second, in increasing order of time resource indexes for time multiplexed ROs within a PRACH slot; and third, in increasing order of indexes for PRACH slots. The unified RA procedure can configure different ROs for the different features.

As a non-limiting example, in Table 6.3.3.2-2 of TS38.211, discussed above, RACH configuration index=19 has two associated subframes (subframe number 1 and subframe number 6). In this examples, ROs are located in subframe number 1 and subframe number 6 with a period of, for example, 10 ms. In each subframe and in the frequency domain, two ROs can be configured. Therefore, for RACH configuration index=19, four ROs can be configured RO-1, RO-2, RO-3, and RO-4. In some examples, different ROs can be configured for two features. For example, RO-1 and RO-4 can be configured for feature 1 and RO-2 and RO-3 can be configured for feature 2. Based on this configuration, the network (e.g., base station 101 of system 100 of FIG. 1) can identify a feature based on the frequency resources in the subframe numbers of the PRACH configuration index used by UE 103.

The example above is provided for illustration and the aspects of this disclosure are not limited to this example. Other PRACH configuration indexes, their associated subframe numbers, and their associated frequency resources can be used for different features supported by base station 101 and UE 103.

Additionally, or alternatively, to using RO partitioning, the unified RA procedure can use preamble partitioning for supporting multiple features simultaneously or substantially simultaneously, according to some aspects. In some examples, the preamble partitioning can be performed when shared ROs are used. According to some aspects, for each feature, the preamble information can include the total preamble number per synchronization signal block (SSB), and the preamble-start-index per SSB. In these examples, the feature specific RACH resource can include a plurality of preamble offsets associated with the plurality of features.

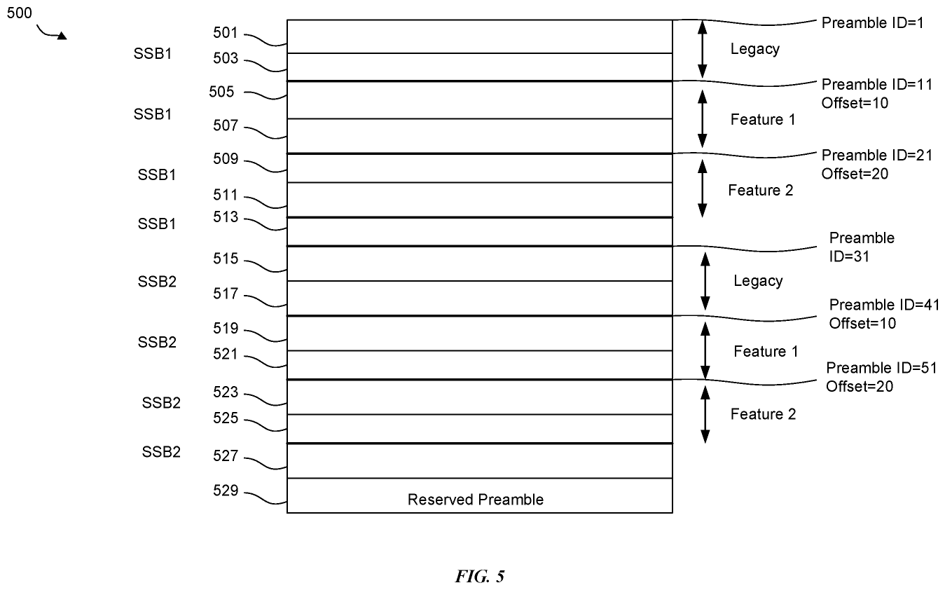

FIG. 5 illustrates an exemplary preamble partitioning, according to some aspects of this disclosure. In this example, two features are supported and used by UE 103 and base station 101. In this example, different preambles are configured for one RO and two SSBs are mapped to the one RO. However, the aspects of this disclosure can include any number of features and/or any number of SSBs.

According to some aspects, preamble partitioning 500 is based on preamble partitioning 440 of FIG. 4C applied to multiple features. Preamble partitioning 500 of FIG. 5 illustrates CB preamble for SSB1 501 for legacy 4-step RA procedure and CB preamble for SSB1 503 for legacy 2-step RA procedure. In a non-limiting example, 501 and 503 can include 10 preamble with preamble identifier (ID) starting at 1 and ending at Preamble partitioning 500 of FIG. 5 further illustrates CB preamble indexes for SSB1 505 for 4-step RA procedure for feature 1 and CB preamble indexes for SSB1 507 for 2-step RA procedure for feature 1. In a non-limiting example, 505 and 507 can include 10 preamble indexes with preamble identifier (ID) starting at 11 and ending at 20. In this example, the preamble offset is 10 for SSB1 for feature 1.

Preamble partitioning 500 of FIG. 5 further illustrates CB preamble indexes for SSB1 509 for 4-step RA procedure for feature 2 and CB preamble indexes for SSB1 511 for 2-step RA procedure for feature 2. In a non-limiting example, 509 and 511 can include 10 preamble indexes with preamble identifier (ID) starting at 21 and ending at 30. In this example, the preamble offset is 20 for SSB1 for feature 2.

Preamble partitioning 500 of FIG. 5 further illustrates CF preamble indexes for SSB1 513.

Preamble partitioning 500 of FIG. 5 further illustrates CB preamble indexes for SSB2 515 for legacy 4-step RA procedure and CB preamble indexes for SSB2 517 for legacy 2-step RA procedure. In a non-limiting example, 515 and 517 can include 10 preamble indexes with preamble identifier (ID) starting at 31 and ending at 40.

Preamble partitioning 500 of FIG. 5 further illustrates CB preamble indexes for SSB2 519 for 4-step RA procedure for feature 1 and CB preamble indexes for SSB2 521 for 2-step RA procedure for feature 1. In a non-limiting example, 519 and 521 can include 10 preamble indexes with preamble identifier (ID) starting at 41 and ending at 50. In this example, the preamble offset is 10 for SSB2 for feature 1.

Preamble partitioning 500 of FIG. 5 further illustrates CB preamble indexes for SSB2 523 for 4-step RA procedure for feature 2 and CB preamble indexes for SSB2 525 for 2-step RA procedure for feature 2. In a non-limiting example, 523 and 525 can include 10 preamble indexes with preamble identifier (ID) starting at 51 and ending at 60. In this example, the preamble offset is 20 for SSB2 for feature 2.

Preamble partitioning 500 of FIG. 5 further illustrates CF preamble indexes for SSB2 527 and reserved preambles 529.

In this exemplary preamble partitioning, the preamble offset is X (per SSB) for the 4-step preambles and 2-step preambles for feature 1. In this example, X is 10. Additionally, the preamble offset is Y (per SSB) for the 4-step preambles and 2-step preambles for feature 2. In this example, Y is 20. However, the aspects of this disclosure can include other number of features, other number of SSBs, and/or other preamble offsets.

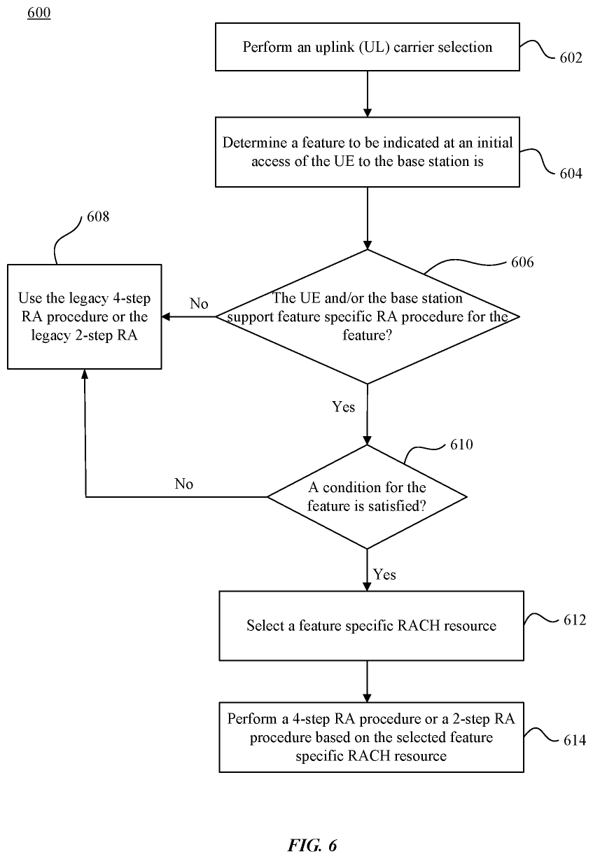

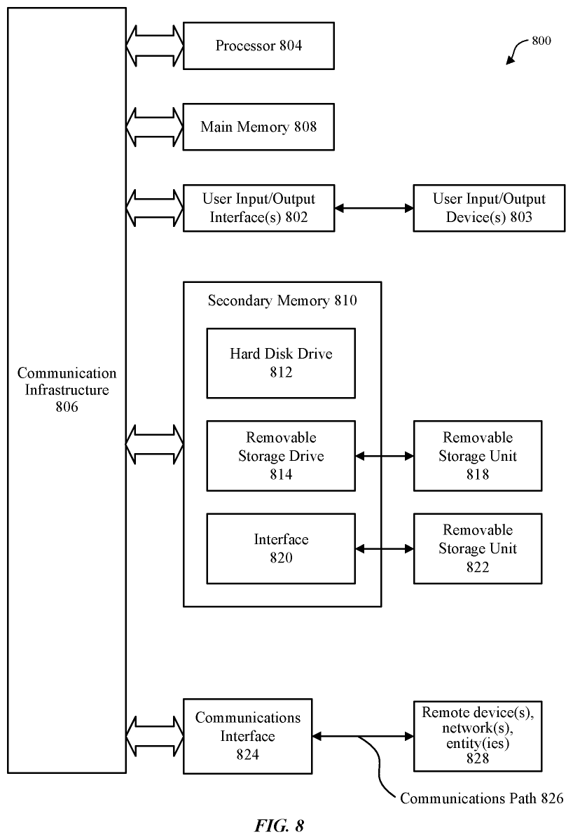

FIG. 6 illustrates an example method for a system (for example, a UE) performing unified RA procedure for multiple features, according to some aspects of the disclosure. As a convenience and not a limitation, FIG. 6 may be described with regard to elements of FIGS. 1-5. Method 600 may represent the operation of an electronic device (for example, UE 103 of FIG. 1) implementing unified RA procedure. Method 600 may also be performed by system 200 of FIG. 2 and/or computer system 800 of FIG. 8. But method 600 is not limited to the specific aspects depicted in those figures and other systems may be used to perform the method as will be understood by those skilled in the art. It is to be appreciated that not all operations may be needed, and the operations may not be performed in the same order as shown in FIG. 6.

At 602, an uplink (UL) carrier selection is performed. For example, UE 103 can perform an UL carrier selection. According to some aspects, performing the UL carrier selection can include comparing a determined Reference Signal Received Power (RSRP) value with an RSRP threshold. For example, UE 103 can determine the RSRP value based on the signals that UE 103 receives from base station 101. In one example, UE 103 can determine RSRP value of the downlink (DL) path-loss (PL) reference and can compare the determined RSRP value with the RSRP threshold. In some examples, the RSRP threshold can include rsrp-ThresholdSSB-SUL.

According to some aspects, UE 103 can select a supplementary UL (SUL) in response to the determined RSRP value being less than the RSRP threshold. UE 103 can select a normal UL (NUL) in response to the determined RSRP value being greater than or equal to the RSRP threshold.

According to some examples, the network (e.g., system 100 including base station 101) can explicitly indicate the UL carrier selection to UE 103. In this example, base station 101 can explicitly indicate the UL carrier to UE 103 to use. In some examples, this explicit indication can occur in a connected mode. According to some examples, no carrier change occurs during the RA procedure.

At 604, a feature to be indicated at an initial access of the UE to the base station is determined. According to some examples, the feature can include, but are not limited to, reduced capability (RedCap) (e.g., a feature that can be used for low cost UEs where the radio quality is low), coverage enhancement, Radio Access Network (RAN) slicing, small data transmission, and the like. Although method 600 is discussed with respect to one feature, the aspects of this disclosure can include performing method 600 for multiple features.

At 606, it is determined whether the UE and/or the base station support feature specific random access (RA) procedure (the unified RA procedure for multiple features) for the determined feature. For example, UE 103 can determine whether UE 103 supports feature specific RA procedure for the determined feature. In a non-limiting example, UE 103 can determine whether UE 103 supports feature specific RA procedure for the determined feature by examining UE 103's capabilities stored, for example, in a memory of UE 103. UE 103 can also determine whether base station 101 supports feature specific RA procedure for the determined feature. In a non-limiting example, UE 103 can determine whether base station 101 supports feature specific RA procedure for the determined feature based on information and configurations that UE 103 receives from base station 101. UE 103 can make determination operation 606 using other methods.

If UE 103 determines that UE 103 or base station 101 does not support feature specific RA procedure for the determined feature, method 600 can move to operation 608. At 608, UE 103 can use the legacy RA procedure (e.g., 2-step or 4-step). According to some aspects, to use the legacy RA procedure, UE 103 can select the legacy 4-step RA procedure or the legacy 2-step RA procedure. In some examples, for Contention Free RACH (CFRA), UE 103 can use a RSRP threshold to select between the 4-step RA procedure or the 2-step RA procedure. If a 4-step CFRA resource is configured, UE 103 can perform the 4-step RA procedure. If a 2-step CFRA resource is configured, UE 103 can perform the 2-step RA procedure. Operation 608 can further include preamble selection and RO selection based on the determined RACH configuration.

If UE 103 determines that UE 103 and base station 101 support feature specific RA procedure for the determined feature, method 600 can move to operation 610. At 610, it is determined whether a condition for the determined feature is satisfied. For example, UE 103 determines whether the condition is satisfied. According to some aspects, the condition is a feature specific condition. In other words, each feature has its associated condition.

In a non-limiting, if the feature selected by UE 103 is coverage enhancement, but radio quality for UE 103 is acceptable (e.g., the quality is better than a threshold), then UE 103 may not want to use unified RA procedure (e.g., the feature specific RA procedure). In this example, the condition for coverage enhancement feature can include quality of the link UE 103 uses for communication with base station 101. UE 103 can measure the radio quality, compare the measured quality with a threshold, and determine whether the condition is satisfied or not.

In a non-limiting, if the feature selected by UE 103 is small data transmission, but radio quality for UE 103 is not acceptable (e.g., the quality is worse (e.g., less) than a threshold), then UE 103 may not want to use unified RA procedure (e.g., the feature specific RA procedure). In this example, since the radio quality is not acceptable, UE 103 may not be able to send large messages and is to send small messages. Therefore, UE 103 may need to specify to base station 101 that UE 103 is selecting small data transmission. In this example, the condition for coverage enhancement feature can include quality of the link UE 103 uses for communication with base station 101. UE 103 can measure the radio quality, compare the measured quality with a threshold, and determine whether the condition is satisfied or not.

The aspects of this disclosure are not limited to these exemplary conditions and can include other feature specific conditions. In some aspects, the conditions are defined such that UE 103 can determine whether using unified RA procedure (e.g., the feature specific RA procedure) is beneficial for UE 103 and/or the network. The conditions can be configured by the network (e.g., system 100 including base station 101) and/or be predefined. In some examples, base station 101 can communicate the feature specific condition(s) to UE 103 using, for example, system information.

If the condition for the determined feature is not satisfied, method 600 can move to operation 608 discussed above. If the condition for the determined feature is satisfied, method 600 can move to operation 612.

At 612, a feature specific RACH resource is selected. For example UE 103 can select the feature specific RACH resource based on the determined feature. According to some aspects, UE 103 selects the feature specific RACH resource based on the determined feature and a feature specific RACH configuration. The feature specific RACH configuration is discussed in more detail below.

According to some aspects, the feature specific RACH resource includes one or more RACH occasions (ROs) or one or more preambles partitioned based on a plurality of features to be indicated at the initial access of the UE to the base station. As discussed above, in some examples, the feature specific RACH resource can include a plurality of PRACH configuration indexes associated with the plurality of features. Additionally, or alternatively, the feature specific RACH resource can include a plurality of sets of subframes for a PRACH configuration index associated with the plurality of features. Additionally, or alternatively, the feature specific RACH resource can include a plurality of frequency resources of a RACH occasion associated with the plurality of features. Additionally, or alternatively, the feature specific RACH resource can include a plurality of RACH occasions associated with the plurality of features, where the plurality of RACH occasions are spread in a frequency domain and a time domain. Additionally, or alternatively, the feature specific RACH resource can include a plurality of preamble offsets associated with the plurality of features.

At 614, a 4-step RA procedure or a 2-step RA procedure is performed based on the selected feature specific RACH resource. For example, after selecting the feature specific RACH resource, UE 103 performs a 4-step RA procedure or a 2-step RA procedure based on the selected feature specific RACH resource.

By using the selected feature specific RACH resource, base station 101 can determine the feature that UE 103 has selected and is about to use. In other words, by using the unified RA procedure of this disclosure (e.g., using the selected feature specific RACH resource for the 4-step RA procedure or the 2-step RA procedure), UE 103 and base station 101 perform the initial access procedure for a specific feature to be used by UE 103. By knowing the feature that UE 103 has selected, base station 101 can perform specific scheduling for the selected features and can communicate specific information and signals to UE 103 based on the selected feature. In a non-limiting example, if the selected feature is RedCap, base station 101 can determine and use specific Modulation and Coding Scheme (MCS) for RedCap feature. In another non-limiting example, if the selected feature is coverage enhancement, base station 101 can allow use of repetitions in, for example, message 3. In another non-limiting example, if the selected feature is RAN slicing, the network (e.g., system 100 including base station 101) can choose a specific slicing from a plurality of slicings based on the selected feature (and/or information associated with the selected RAN slicing). In another non-limiting example, if the selected feature is small data transmission, the network (e.g., system 100 including base station 101) can choose a specific Transport Block (TB) size based on the selected feature. For example, base station 101 can allow use of larger message 3, as one example, if the selected feature is small data transmission.

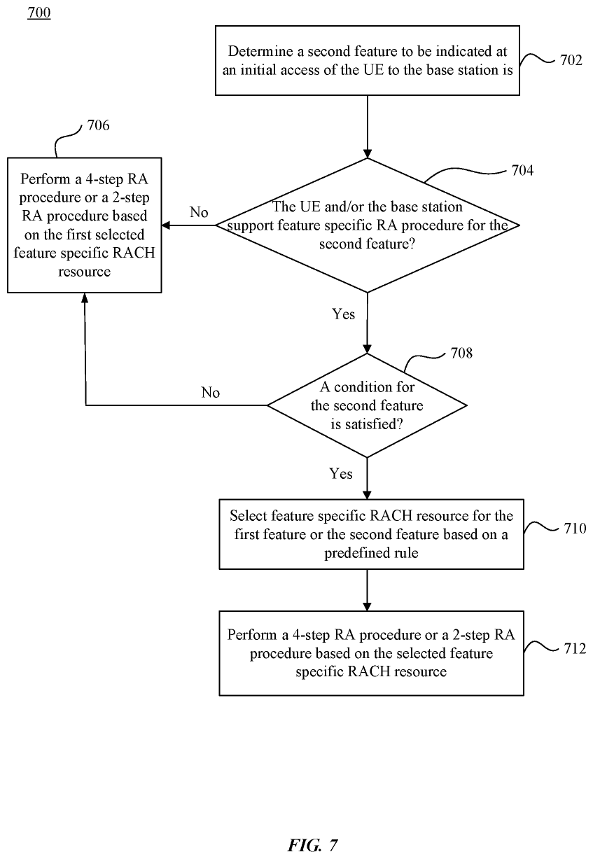

FIG. 7 illustrates another example method for a system (for example, a UE) performing unified RA procedure for multiple features, according to some aspects of the disclosure. As a convenience and not a limitation, FIG. 7 may be described with regard to elements of FIGS. 1-6. Method 700 may represent the operation of an electronic device (for example, UE 103 of FIG. 1) implementing unified RA procedure for multiple features. Method 700 may also be performed by system 200 of FIG. 2 and/or computer system 800 of FIG. 8. But method 700 is not limited to the specific aspects depicted in those figures and other systems may be used to perform the method as will be understood by those skilled in the art. It is to be appreciated that not all operations may be needed, and the operations may not be performed in the same order as shown in FIG. 7.

According to some aspects, method 700 can be performed in addition to method 600. For example, method 600 can be used for selecting and using feature specific RACH resource for the 4-step RA procedure or the 2-step RA procedure for a first feature. Method 700 can be used for selecting and using feature specific RACH resource for the 4-step RA procedure or the 2-step RA procedure for a second feature. In other words, if both UE 103 and base station 101 support multiple features (e.g., a first feature and a second feature), UE 103 can check RACH conditions for the multiple features. If one feature's condition is satisfied, UE 103 can perform unified RA procedure according to the feature specific RACH resource of that feature. If multiple features' conditions are satisfied, UE 103 can select the feature specific RACH resource for multiple features based on a predefined rule.

At 702, a second feature to be indicated at the initial access of the UE to the base station is determined. For example, UE 103 determine a second feature (in addition to the first feature determine at 604 of FIG. 6).

At 704, it is determined whether the UE and the base station support a second feature specific RA procedure for the second features. Operation 704 can be similar to operation 606 of FIG. 6 performed for the second feature.

In response to determining that the UE or the base station does not support the second feature specific RA procedure for the second feature, method 700 moves to operation 706. At 706, the 4-step RA procedure or the 2-step RA procedure based on the selected feature specific RACH resource for first feature is performed. Operation 706 can be similar to operation 614 of FIG. 6.

In response to determining that the UE and the base station support the second feature specific RA procedure for the second feature, method 700 moves to operation 708. At 708, it is determined whether a second condition for the second feature is satisfied. Operation 708 can be similar to operation 610 of FIG. 6 performed for the second feature.

In response to determining that the second condition is not satisfied, method 700 can move to operation 706.

In response to determining that the second condition is satisfied, method 700 can move to operation 710. At 710, the feature specific RACH resource for the first feature or a second feature specific RACH resource for the second feature is selected. For example, UE 103 can select feature specific RACH resource for the first feature or the second feature based on a predefined rule.

In some examples, the predefined rule can include priorities assigned to the first and second features. For example, UE 103 can select the feature specific RACH resource for the first feature or the second feature specific RACH resource for the second feature based on priorities assigned to the first feature and the second feature.

According to some aspects, the predefined rule (e.g., the priorities) can be based on UE 103's implementation. Additionally, or alternatively, the predefined rule (e.g., the priorities) can be configured by the network (e.g., system 100 and/or base station 101 of FIG. 1). Additionally, or alternatively, the predefined rule (e.g., the priorities) can be configured in a technical specification.

In a non-limiting example, the predefined rule (e.g., the priorities) can include small data transmission (SDT)/RedCap/coverage Enhancement having higher priority than RAN slicing; SDT having higher priority than RedCap/coverage enhancement; and/or coverage enhancement having higher priority than RedCap. However, the aspects of this disclosure can include other rules/priorities.

According to some aspects, at 710, UE 103 can select the feature with the highest priority to perform the unified RA procedure. In this example, UE 103 can select feature specific RACH resource for feature with the highest priority.

At 712, a 4-step RA procedure or a 2-step RA procedure is performed based on the selected feature specific RACH resource for the first feature or the selected second feature specific RACH resource for the second feature. For example, UE 103 performs the 4-step RA procedure or the 2-step RA procedure based on the feature specific RACH resource selected at 710.

According to some aspects, for the retransmission cases, the same RACH configuration can be used for both RACH initial and retransmission procedure, according to some aspects of this disclosure. For example, if a feature specific RACH configuration is used for transmission, the same feature specific RACH configuration will be used for retransmission.

If a condition for retransmission is satisfied, UE 103 can use fallback procedures, according to some aspects of this disclosure. In one example, the condition for retransmission can include a number of retransmissions being more than a threshold. For example, if UE 103 retransmits a preamble for a given number of times (e.g., more than the threshold), and still the RA procedure fails, UE 103 can use fallback procedures. In some examples, if UE 103 selects the 2-step RA procedure in operations 614 and/or 712 for the selected feature specific RACH resource and the 2-step RA procedure fails (e.g., for the given number of times), UE 103 can use the 4-step RA procedure for the selected feature specific RACH resource as a fallback. Additionally, or alternatively, if the 2-step RA procedure fails, UE 103 can use a legacy 4-step RA procedure as a fallback (e.g., not use RA procedure for the selected feature specific RACH resource). Additionally, or alternatively, if the 2-step RA procedure fails, UE 103 can use a legacy 2-step RA procedure as a fallback (e.g., not use RA procedure for the selected feature specific RACH resource).

According to some aspects, UE 103 can select the feature specific RACH resource (e.g., operations 612 of FIG. 6 and/or 710 of FIG. 7) based on the determined feature (e.g., the first feature and/or second feature) and a feature specific RACH configuration.

In one exemplary aspect, the feature specific RACH configuration can include a general RACH configuration and a plurality of specific RACH configurations. The general RACH configuration can include information associated with the plurality of specific RACH configurations. For example, the general RACH configuration can include information associated with the number of the plurality of specific RACH configurations. In a non-limiting example, system 100 can support six features and the number of the plurality of specific RACH configurations in the general RACH configuration can be six. The general RACH configuration can also include a mapping between the features and the plurality of specific RACH configurations. In a non-limiting example, the mapping can indicate that specific RACH configuration 1 is associated with small data transmission, specific RACH configuration 2 is associated with RedCap, specific RACH configuration 3-5 are associated with RAN slicing, and specific RACH configuration 6 is associated with coverage enhancement. The aspects of this disclosure are not limited to these examples and other numbers of specific RACH configurations and other mappings can be used.

According to some aspects, each of the plurality of specific RACH configurations can include information (e.g., feature specific RACH resource(s)) for its corresponding feature. For example, each of the plurality of specific RACH configurations can include RO partitioning and/or preamble partitioning for its corresponding feature. The feature specific information can include feature specific information for a 4-step RA procedure and/or a 2-step RA procedure. Also, each of the plurality of specific RACH configurations can include information indicating Msg A/B group are supported in both 4-step RACH and 2-step RACH configuration.

According to some aspects, each of the plurality of specific RACH configurations can include information (e.g., feature specific RACH resource(s)) for a corresponding group of two or more features.

In another exemplary aspect, the feature specific RACH configuration can include a first feature specific RACH configuration associated with the 4-step RA procedure and a second feature specific RACH configuration associated with the 2-step RA procedure. In this example, the network (e.g., system 100 including base station 101) can provide one common RACH occasion pool for features for 4-step RACH and one common RACH occasion pool for features for 2-step RACH.

The first feature specific RACH configuration associated with the 4-step RA procedure (e.g., the one common RACH occasion pool for features for 4-step RACH) can include a feature list indicating the features supported by system 100. The first feature specific RACH configuration associated with the 4-step RA procedure further includes feature specific RACH configuration (e.g., feature specific RACH resource(s)) for each feature (or for a group of features). The feature specific RACH configuration can include feature name, RO list, and/or preamble list for each feature (or for a group of features). In some examples, the first feature specific RACH configuration associated with the 4-step RA procedure (e.g., the one common RACH occasion pool for features for 4-step RACH) can number ROs first, in increasing order of frequency resource indexes for frequency multiplexed ROs; second, in increasing order of time resource indexes for time multiplexed ROs within a RACH slot; and third, in increasing order of indexes for RACH slots.

The second feature specific RACH configuration associated with the 2-step RA procedure (e.g., the one common RACH occasion pool for features for 2-step RACH) can include a feature list indicating the features supported by system 100. The first feature specific RACH configuration associated with the 2-step RA procedure further includes feature specific RACH configuration (e.g., feature specific RACH resource(s)) for each feature (or for a group of features). The feature specific RACH configuration can include feature name, RO list, and/or preamble list for each feature (or for a group of features). In some examples, the second feature specific RACH configuration associated with the 2-step RA procedure (e.g., the one common RACH occasion pool for features for 2-step RACH) can provide a valid 2-step RO and preambles used for each feature. In some examples, the second feature specific RACH configuration associated with the 2-step RA procedure can number ROs first, in increasing order of frequency resource indexes for frequency multiplexed ROs; second, in increasing order of time resource indexes for time multiplexed ROs within a RACH slot; and third, in increasing order of indexes for RACH slots.

According to some aspects, base station 101 can communicate the feature specific RACH configuration to UE 103 using system information messages such as, but not limited to, System Information Block 1 (SIB 1) or the like. However, the feature specific RACH configuration can be communicated to UE 103 using other methods.

Various aspects can be implemented, for example, using one or more computer systems, such as computer system 800 shown in FIG. 8. Computer system 800 can be any well-known computer capable of performing the functions described herein such as devices 101, 103 of FIG. 1, and/or 200 of FIG. 2. Computer system 800 includes one or more processors (also called central processing units, or CPUs), such as a processor 804. Processor 804 is connected to a communication infrastructure 806 (e.g., a bus). Computer system 800 also includes user input/output device(s) 803, such as monitors, keyboards, pointing devices, etc., that communicate with communication infrastructure 806 through user input/output interface(s) 802. Computer system 800 also includes a main or primary memory 808, such as random access memory (RAM). Main memory 808 may include one or more levels of cache. Main memory 808 has stored therein control logic (e.g., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 includes a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 reads from and/or writes to removable storage unit 818 in a well-known manner.

According to some aspects, secondary memory 810 may include other means, instrumentalities or other approaches for allowing computer programs and/or other instructions and/or data to be accessed by computer system 800. Such means, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 enables computer system 800 to communicate and interact with any combination of remote devices, remote networks, remote entities, etc. (individually and collectively referenced by reference number 828). For example, communication interface 824 may allow computer system 800 to communicate with remote devices 828 over communications path 826, which may be wired and/or wireless, and which may include any combination of LANs, WANs, the Internet, etc. Control logic and/or data may be transmitted to and from computer system 800 via communication path 826.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 800, main memory 808, secondary memory 810 and removable storage units 818 and 822, as well as tangible articles of manufacture embodying any combination of the foregoing. Such control logic, when executed by one or more data processing devices (such as computer system 800), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 8. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “aspects” “an example,” “examples,” or similar phrases, indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

1. A user equipment (UE), comprising:
a transceiver configured to enable wireless communication with a base station; and
a processor communicatively coupled to the transceiver and configured to:
determine a feature to be indicated at an initial access of the UE to the base station;
determine whether the UE and the base station support feature specific random access (RA) procedure for the feature;
in response to determining that both the UE and the base station support the feature specific RA procedure for the feature, determine whether a condition for the feature is satisfied; and
in response to determining that the condition is satisfied:
select a feature specific Random Access Channel (RACH) resource; and
perform a 4-step RA procedure or a 2-step RA procedure based on the selected feature specific RACH resource.

2. The UE of claim 1, wherein the feature is one of a plurality of features to be indicated at the initial access of the UE to the base station and wherein the feature specific RACH resource comprises one or more RACH occasions or one or more preambles partitioned based on the plurality of features.

3. The UE of claim 2, wherein the feature specific RACH resource comprises a plurality of Physical Random Access Channel (PRACH) configuration indexes associated with the plurality of features.

4. The UE of claim 2, wherein the feature specific RACH resource comprises a plurality of sets of subframes for a Physical Random Access Channel (PRACH) configuration index associated with the plurality of features.

5. The UE of claim 2, wherein the feature specific RACH resource comprises a plurality of frequency resources of a RACH occasion associated with the plurality of features.

6. The UE of claim 2, wherein the feature specific RACH resource comprises a plurality of RACH occasions associated with the plurality of features and wherein the plurality of RACH occasions are spread in a frequency domain and a time domain.

7. The UE of claim 2, wherein the feature specific RACH resource comprises a plurality of preamble offsets associated with the plurality of features.

8. The UE of claim 1, wherein the processor is configured to select the feature specific RACH resource based on the determined feature and a feature specific RACH configuration.

9. The UE of claim 8, wherein the feature specific RACH configuration includes a general RACH configuration and a plurality of specific RACH configurations. (Original) The UE of claim 9, wherein the general RACH configuration comprises a number of the plurality of specific RACH configurations and a mapping between a plurality of features and the plurality of specific RACH configurations.

11. The UE of claim 9, wherein each of the plurality of specific RACH configurations comprises information associated with a 4-step RA procedure or a 2-step RA procedure associated with the corresponding feature of the plurality of features.

12. The UE of claim 8, wherein the feature specific RACH configuration comprises a first feature specific RACH configuration associated with the 4-step RA procedure and a second feature specific RACH configuration associated with the 2-step RA procedure.

13. The UE of claim 1, wherein the processor is further configured to:
determine whether the UE and the base station support a second feature specific RA procedure for a second feature;
in response to determining that the UE or the base station does not support the second feature specific RA procedure for the second feature, perform the 4-step RA procedure or the 2-step RA procedure based on the selected feature specific RACH resource; and
in response to determining that the UE and the base station support the second feature specific RA procedure for the second feature, determine whether a second condition for the second feature is satisfied;
in response to determining that the second condition is satisfied:
select the feature specific RACH resource for the feature or a second feature specific RACH resource for the second feature; and
perform a 4-step RA procedure or a 2-step RA procedure based on the selected feature specific RACH resource or the selected second feature specific RACH resource; and
in response to determining that the second condition is not satisfied, perform the 4-step RA procedure or the 2-step RA procedure based on the selected feature specific RACH resource.

14. The UE of claim 13, wherein the process is configured to select the feature specific RACH resource for the feature or the second feature specific RACH resource based on priorities assigned to the feature and the second feature.

15. A method, comprising:
determining, by a user equipment (UE), a feature to be indicated at an initial access of the UE to a base station;
determining whether the UE and the base station support feature specific random access (RA) procedure for the feature;
in response to determining that both the UE and the base station support the feature specific RA procedure for the feature, determining whether a condition for the feature is satisfied; and
in response to determining that the condition is satisfied:
selecting a feature specific Random Access Channel (RACH) resource; and
performing a 4-step RA procedure or a 2-step RA procedure based on the selected feature specific RACH resource.

16. The method of claim 15, wherein the feature is one of a plurality of features to be indicated at the initial access of the UE to the base station and wherein the feature specific RACH resource comprises one or more RACH occasions or one or more preambles partitioned based on the plurality of features.

17. The method of claim 16, wherein the feature specific RACH resource comprises one or more of:
a plurality of Physical Random Access Channel (PRACH) configuration indexes associated with the plurality of features,
a plurality of sets of subframes for a PRACH configuration index associated with the plurality of features,
a plurality of frequency resources of a RACH occasion associated with the plurality of features,
a plurality of RACH occasions associated with the plurality of features, wherein the plurality of RACH occasions are spread in a frequency domain and a time domain, or
a plurality of preamble offsets associated with the plurality of features.

18. The method of claim 15, wherein selecting the feature specific RACH resource comprises selecting the feature specific RACH resource based on the determined feature and a feature specific RACH configuration.

19. The method of claim 18, wherein:
the feature specific RACH configuration includes a general RACH configuration and a plurality of specific RACH configurations, or
the feature specific RACH configuration comprises a first feature specific RACH configuration associated with the 4-step RA procedure and a second feature specific RACH configuration associated with the 2-step RA procedure.

20. A non-transitory computer-readable medium storing instructions that when executed by a processor of a user equipment (UE) cause the processor to perform operations comprising:
determining a feature to be indicated at an initial access of the UE to a base station;
determining whether the UE and the base station support feature specific random access (RA) procedure for the feature;
in response to determining that both the UE and the base station support the feature specific RA procedure for the feature, determining whether a condition for the feature is satisfied; and
in response to determining that the condition is satisfied:
selecting a feature specific Random Access Channel (RACH) resource; and
performing a 4-step RA procedure or a 2-step RA procedure based on the selected feature specific RACH resource.
